(19) United States
(12) Patent Application Publication
(10) Pub. No.: US 2025/0271094 A1
(43) Pub. Date: Aug. 28, 2025

(54) FIELD JOINT METHOD AND APPARATUS

(71) Applicant: 2543500 ALBERTA LTD., D.B.A. SHAW PIPE PROTECTION, Calgary (CA)

(72) Inventors: Torgeir SLELVOLD, Toronto (CA); Jim Ronny OLSEN, Toronto (CA); Terje GRYTBAKK, Toronto (CA); Eileen WAN, Toronto (CA)

(21) Appl. No.: 19/207,133

(22) Filed: May 13, 2025

Related U.S. Application Data
(63) Continuation of application No. PCT/CA2023/051464, filed on Nov. 15, 2022.
(60) Provisional application No. 63/425,385, filed on Nov. 15, 2022.

(51) Int. Cl. F16L 58/18; B28B 21/92; F16L 58/10

(52) U.S. Cl. CPC F16L 58/181; B28B 21/92; F16L 58/109

(57) ABSTRACT

The present invention provides a machine and method for applying multiple coatings around a segment of the pipe. The machine includes a frame with a carriage that is rotatable around a periphery of the pipe segment, a heating element mounted on the frame for heating the pipe segment, an anti-corrosion applicator mounted on the carriage for applying an anti-corrosion coating onto the pipe segment, and a polymer applicator mounted on the carriage sequentially adjacent to the anti-corrosion applicator for applying a polymer coating onto the pipe segment. The anti-corrosion applicator and the polymer applicator apply their respective coatings onto the pipe segment as the carriage rotates in one direction.

### RELATED APPLICATION DATA

The present application is a continuation of international PCT patent application no. PCT/CA2023/051464 filed Nov. 2, 2023, which claims priority to, and the benefit of, U.S. provisional patent application No. 63/425,385, filed Nov. 15, 2022, the content of both of these documents being incorporated herein by reference.

### FIELD OF INVENTION

The present invention relates to a machine and a method for coating a pipe or a pipe segment. In particular, the invention concerns a machine and a method for coating steel pipes and field joints with multiple coats for protecting the pipe segment and, in particular, field joints.

### BACKGROUND OF THE INVENTION

Steel pipes or conduits used in oil and gas transportation applications are typically coated for corrosion resistance, impact resistance, and often thermal insulation. Discrete pipe lengths, for example 12 metre pipe lengths, are coated in a factory, with what is referred to in the art as a “linepipe coating”. Linepipe coating typically involves a powder coating, an extrusion coating, or a multi-layer coating comprising both powder and extrusion coats. In many cases, the linepipe coating comprises a thin fusion bonded epoxy (FBE) layer directly on the pipe, for corrosion resistance, often referred to as an “anti-corrosion coating” or ACC.

This corrosion resistance layer is generally followed by a thicker, primarily polyolefin-based extrusion applied coating for impact resistance, thermal insulation, and other desirable properties. It is sometimes the case that the ACC is defined as both the thin FBE layer and protective polyolefin-based coating together. In some cases, a linepipe coating may further comprise a solid, foam, or syntactic insulation layer, which is, in turn, coated with a polyolefin-based rigid topcoat.

Linepipe coatings cover most of the pipe surface, providing the desirable corrosion and impact resistance. However, typically, a small area at each end of the discrete pipe length (for example, 200 mm) is left bare, so that the pipe lengths can be welded together to form much longer pipelines in the field or at a location closer to the installation point. Often, linepipe coatings also comprise a chamfer area, where the coating is chamfered from its full thickness to zero thickness at the bare steel pipe. The bare steel and chamfered coating sections of pipe are generally referred to as the “cutback region”.

Linepipe coatings provide excellent uniformity of coating, since they are applied in a factory setting, where coating variables, such as temperature, dust control, extrusion mix and speed, etc., can be tightly controlled to desired parameters.

The pipe lengths are then joined in the field into much longer pipe lengths or pipelines, by welding the steel ends of two pipes together in a “girth weld” or “butt weld” to create a “field joint”. Since the field joint area is “raw” or uncoated, a coating around the cutback region of both pipes, typically referred to as a “field joint coating”, must be applied in the field. Field joint coatings may be added by many different means, including shrink-applied casings, or cast or injection molded polyolefins.

However, coating a pipe in factory conditions, with controlled temperature and humidity, using large stable machines with large stable supplies of polyolefin etc., is starkly different from coating a pipe in the field. The locations may be remote, such as in a farmer's field, a desert, or on a lay barge at sea. Given the widely varying, and potentially extreme, conditions under which the coatings may be applied, the materials used in the field joint generally have to be of higher tolerances than those applied under factory conditions.

In many cases, it is also a very manual process. For example, if pre-stretched shrink wraps made of polyethylene are used, the standard practice is to put the sleeve onto the pipe before welding, or to wrap the pipe after welding. To do so, the pipe must first be cleaned of any rust etc., which may be a manual or automated blast process, like a sand blasting. The pipe is then heated and a fusion bonded epoxy powder is sprayed on, which melts onto the hot pipe The shrink sleeve is then fitted onto the pipe and shrink wrapped using hand-held propane torches.

Such a process is only made more difficult when it must be performed in remote and/or extreme environments by workers who may not have sufficient time, training and/or experience in applying the coats. The result may be inadequate or inconsistent field joint coatings. Thus, the process of creating a high quality field joint coating is often time consuming and expensive.

European patent EP 2477758 (incorporated herein by reference) discloses a rotating carriage with an epoxy application means and a polyolefin application means. The carriage rotates in one direction to apply the epoxy, then in the other direction to apply the polyolefin.

### SUMMARY OF THE INVENTION

The present invention provides a machine that is releasably securable to a pipe for applying multiple coatings around a segment of the pipe, the machine comprising: a frame with a carriage that is rotatable around a periphery of the pipe segment; a heating element mounted on the frame for heating the pipe segment; an anti-corrosion applicator mounted on the carriage for applying an anti-corrosion coating onto the pipe segment; and a polymer applicator mounted on the carriage sequentially adjacent to the anti-corrosion applicator for applying a polymer coating onto the pipe segment; wherein the anti-corrosion applicator and the polymer applicator apply their respective coatings onto the pipe segment as the carriage rotates in one direction.

In another aspect, the present invention also provides method for applying coatings around a segment of a pipe, the method comprising: releasably securing a coating machine to the pipe proximate the pipe segment, the coating machine having: a frame with a carriage configured to be rotatable around a periphery of the pipe segment, a heating element mounted on the frame, an anti-corrosion applicator mounted on the carriage, and a polymer applicator mounted on the carriage; heating the pipe segment with the heating element; applying an anti-corrosion coating onto the pipe segment with the anti-corrosion applicator; and applying a polymer coating onto the pipe segment with the polymer applicator; wherein the polymer coating is applied following the anti-corrosion coating as the carriage rotates in one direction.

Additional features and advantages of the invention will be described hereinafter which form the subject of the claims of the invention. It should be appreciated by those skilled in the art that the specific embodiment disclosed herein may be readily utilized as a basis for modifying or designing other structures for carrying out the same purposes of the present invention. It should also be realized by those skilled in the art that such equivalent constructions do not depart from the scope of the invention. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF DRAWINGS

FIG. 1 is a front perspective view of a coating machine according to an example embodiment of the present disclosure.

FIG. 2 is a top perspective view of the coating machine of FIG. 1 in use with a pipe.

FIG. 3 is a front schematic view of the coating machine of FIG. 1 with a pipe.

FIG. 4 is a flowchart setting forth the steps of an example method for applying coatings around a segment of a pipe.

FIG. 5 is a schematic illustration of the method of FIG. 4 using the coating machine of FIG. 3.

FIG. 6 is a schematic illustration of the method of FIG. 4 after the coatings have been applied to the pipe.

FIG. 7a is a side elevational view of the pipe and pipe segment prior to the application of the coatings.

FIG. 7b is a side elevational view of the pipe segment of FIG. 7a with an anti-corrosion coating.

FIG. 7c is a side elevational view of the pipe segment of FIG. 7b with a polymer coating.

FIG. 7d is a side elevational view of the pipe segment of FIG. 7c with a tie coating.

FIG. 7e is a side elevational view of the pipe segment of FIG. 7d with insulation.

FIG. 8 is a partial, cross-sectional view of the pipe segment along line 8-8 of FIG. 7e.

### DETAILED DESCRIPTION OF THE INVENTION

Referring to the Figures, the present disclosure relates to a coating machine 10 and method 400 that allows for the application of multiple coatings onto a pipe 100, notably a segment 102 of pipe 100, in a single, automated pass or rotation cycle. In this manner, a polymer sheet may be applied while the anti-corrosion coating is still hot and at least partially uncured.

While coating machine 10 may be releasably securable about any section of pipe 100, the present application is particularly relevant to pipe segment 102 which comprises two pipe ends that are welded together with a weld 104, often referred to as a field joint 106. As noted above, field joint 106 is typically flanked by bare steel sections 108, collectively referred to as a cutback region 110. Cutback region 110 itself is generally flanked by chamfered sections 112, which are the region on pipe 100 where the factory coating “tapers” down to exposed steel sections 108. In the present embodiment, pipe segment 102 includes steel sections 108/cutback region 110 and chamfered sections 112.

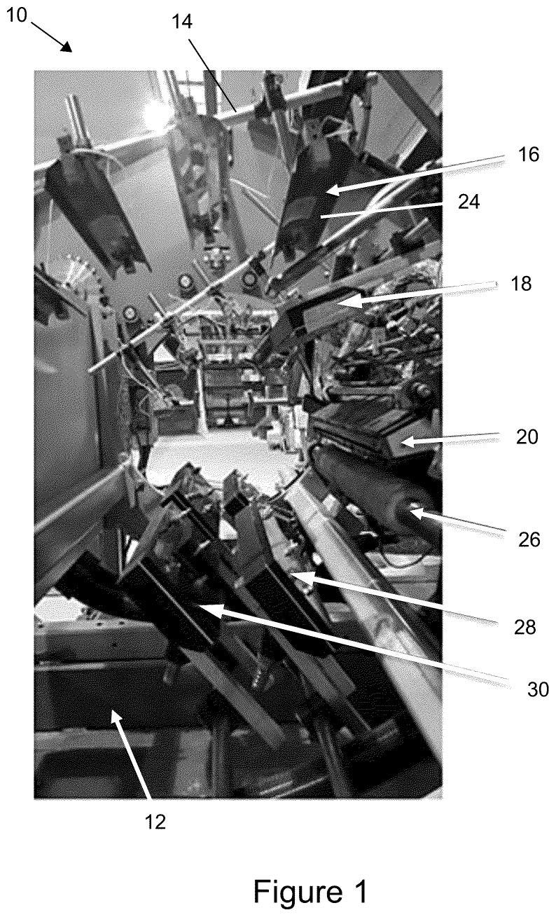

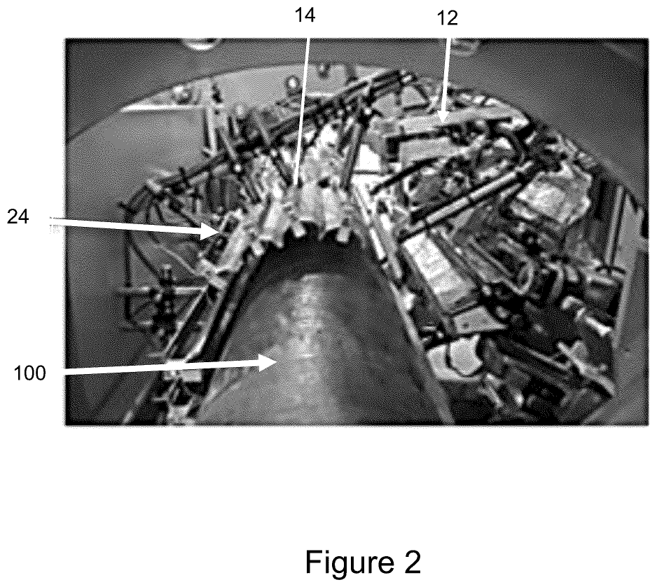

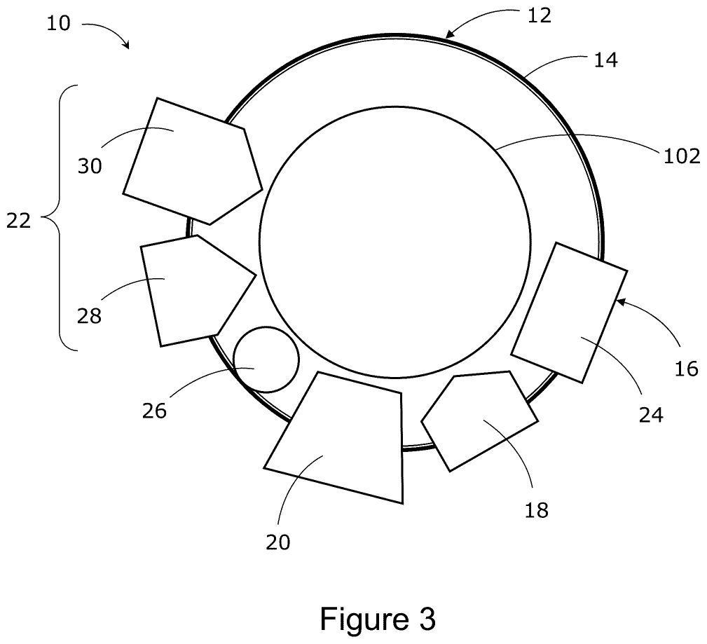

An embodiment of coating machine 10 is shown in FIGS. 1-3, that is releasably securable to pipe 100 about field joint 106. Coating machine 10 generally includes a frame 12 with a rotating carriage 14, a heating element 16, an anti-corrosion applicator 18 mounted on carriage 14, a polymer applicator 20 also mounted on carriage 14, and a tie-coat applicator 22.

Frame 12 is releasably securable about pipe segment 102 and includes carriage 14 which is rotatable around a periphery of pipe segment 102. Frame 12 may comprise a non-rotating portion (not shown), such as a clamp, that can releasably secure frame 12 to pipe 100. Carriage 14, in turn, is rotatably fixed to the non-rotating portion.

Heating element 16 is designed or configured to heat pipe segment 102. In the present embodiment, heating element 16 is an infrared radiation (IR) heater 24 that is mounted on carriage 14 for rotation about pipe segment 102. As depicted, IR heater 24 is positioned to extend along an entire length of pipe segment 112 in order to heat the length of pipe segment 102.

In some applications, IR heater 24 may comprise multiple components that may be configured to apply different levels of heat to different portions of pipe segment 102. For example, one of the components of IR heater 24 may be positioned to heat chamfered sections 112 of pipe segment 102, and another one of the components of IR heater 24 may be positioned to heat steel sections 108. In this manner, the level of heat applied to chamfered sections 112 may be lower or higher, as desired, relative to the heat applied to steel sections 108. In another example, IR heater 24 may only be positioned above or proximate chamfered sections 110 to heat the existing factory coatings, or only positioned above or proximate steel sections 108. As discussed further below, in certain embodiments, IR heater 24 (or a second IR heater (not shown) may be positioned to heat an intermediate adhesive powder application.

While IR heater 24 is shown mounted on carriage 14 so it rotates with carriage 14, in other applications, IR heater 24 may alternately be secured to or mounted on the non-rotating portion of frame 12. In this manner, IR heater 24 can remain stationary relative to pipe segment 102 as carriage 14 rotates about pipe segment 102. In applications where IR heater 24 comprises multiple components, one of the multiple components may be mounted on the non-rotating portion of frame 12 while another one of the multiple components may be mounted on carriage 14.

As well, while IR heater 24 is presently described, heating element 16 may alternately or additionally include other types of heaters, such as induction heaters.

Anti-corrosion applicator 18 is mounted on carriage 14 for applying an anti-corrosion coating onto pipe segment 102. In the present embodiment, since heating element 16 is mounted on carriage 14, anti-corrosion applicator 18 is secured sequentially adjacent to IR heater 24.

Anti-corrosion applicator 18 may be a die or a nozzle configured to apply the anti-corrosion coating along the length of pipe segment 102, including steel sections 108 and chamfered sections 112. In that regard, a nozzle may be used and configured to spray powdered fusion bonded epoxy or liquid epoxy onto pipe segment 102. The anti-corrosion applicator die or nozzle may alternately be configured to apply the corresponding coating onto a portion of pipe segment 102, such as only steel sections 108 or cutback region 110.

In an alternate embodiment, anti-corrosion applicator 18 may comprise multiple nozzles or dies sequentially or circumferentially arranged on carriage 14. In this manner, the multiple dies or nozzles may apply multiple, consecutive layers of the anti-corrosion coating onto pipe segment 102, if for example, a thicker coat is desired.

Polymer applicator 20 is also mounted on carriage 14, and is adapted to apply a polymer coating onto pipe segment 102. As depicted, polymer applicator 20 is mounted on carriage 14 sequentially adjacent to anti-corrosion applicator 18.

Polymer applicator 20 may be a die or a nozzle configured to apply the polymer coating along the length of pipe segment 102, including steel sections 108 and chamfered sections 112. The polymer applicator die or nozzle may alternately be configured to apply the corresponding coating onto a portion of pipe segment 102, such as only steel sections 108 or cutback region 110. In the present embodiment, polymer applicator 20 is a die that extrudes a sheet of molten polymer onto pipe segment 102.

In an alternate embodiment, polymer applicator 20 may comprise multiple dies that are sequentially or circumferentially arranged on carriage 14. In such a manner, the multiple dies may apply multiple, consecutive layers of molten polymer onto pipe segment 102.

Coating machine 10 further optionally includes a levelling means or roller 26 positioned after or sequentially adjacent to polymer application 20. Roller 26 is configured to level and smooth out the polymer coating or molten polymer sheet against the outer surface of pipe segment 102.

Since anti-corrosion applicator 18 is positioned behind or downstream from IR heater 24, and polymer applicator 20 is positioned behind or downstream from anti-corrosion applicator 18, the applicators can sequentially apply their respective coatings onto pipe segment 102 as carriage 14 rotates in one direction.

In the present embodiment, carriage 14 is adapted to rotate in a counter-clockwise direction relative to pipe segment 102. Thus, IR heater 24, anti-corrosion applicator 18, and polymer applicator 20 are also arranged, sequentially, counter-clockwise on carriage 14 starting from IR heater. In a similar manner, if carriage 14 is adapted to rotate in a clockwise direction, IR heater 24, anti-corrosion applicator 18, and polymer applicator 20 may be arranged, sequentially, clockwise on carriage 14 starting from IR heater 24.

As depicted in the Figures, coating machine 10 further includes optional tie-coat applicator 22. Tie-coat applicator 22 is mounted on carriage 14, and is adapted to apply a tie coating onto pipe segment 102. As depicted, tie-coat applicator 22 is mounted on carriage 14 sequentially adjacent to polymer applicator 20. Since carriage 14 is presently adapted to rotate in the counter-clockwise direction, tie-coat applicator 22 is positioned, sequentially, counter-clockwise on carriage 14 following polymer applicator 20.

In the present embodiment, tie-coat applicator 22 includes an epoxy applicator 28 and an adhesive applicator 30. Epoxy applicator 28 is configured to apply an epoxy coating onto pipe segment 102 and adhesive applicator 30 is configured to apply an adhesive coating onto pipe segment 102.

Similar to anti-corrosion applicator 18, epoxy applicator 28 and adhesive applicator 30 may be a die or a nozzle configured to apply the corresponding epoxy and adhesive coatings along the length of pipe segment 102, including steel sections 108 and chamfered sections 112. Epoxy applicator 28 and adhesive applicator 30 die or nozzle may alternately be configured to apply the corresponding coating onto a portion of pipe segment 102, such as just steel sections 108 or cutback region 110. In that regard, epoxy applicator 28 and adhesive applicator 30 may each include a nozzle that is configured to spray the coating in powdered or liquid form onto pipe segment 102.

In others embodiments, epoxy applicator 28 and adhesive applicator 30 may each comprise multiple nozzles or dies sequentially or circumferentially arranged on carriage 14. In this manner, the multiple dies or nozzles may apply multiple, consecutive layers of the epoxy or adhesive coatings onto pipe segment 102.

As depicted, epoxy applicator 28 is mounted on carriage 14 sequentially adjacent to roller 26, and adhesive applicator 30 is mounted on carriage 14 sequentially adjacent to epoxy applicator 28. Since carriage 14 is presently adapted to rotate in the counter-clockwise direction, epoxy applicator 28 and adhesive applicator 30 are positioned, sequentially, counter-clockwise on carriage 14 following polymer applicator 20 and roller 26. The corresponding arrangement would apply if carriage 14 was adapted to rotate in the clockwise direction.

In alternate applications, the position of epoxy applicator 28 and adhesive applicator 30 may be switched, in that adhesive applicator 30 may be mounted on carriage 14 sequentially adjacent to roller 26, while epoxy applicator 28 may be mounted on carriage 14 sequentially adjacent to adhesive applicator 30. In yet other applications, tie-coat applicator 22 may include only epoxy applicator 28 or only adhesive applicator 30.

Each of the dies or nozzles is fed the corresponding coating through pressurized tubes, which lead to an external supply of the coating. The external supplies are not mounted on carriage 14, and thus, do not rotate. In certain applications, the tubes should therefore be long and flexible enough to wrap around the carriage as the carriage turns around the pipe.

In further embodiments, the coating machine 10 may also include an adhesive powder applicator (not shown), configured to apply an adhesive powder via powder spray, onto the anti-corrosion coating and before the application of the molten polymer. In certain embodiments, the adhesive powder application is configured to apply the adhesive powder before the anti-corrosion coating has gelled. Optionally, the IR heater 24, or a secondary IR heater (not shown) may be used to heat the adhesive powder before application of the molten polymer sheet by the polymer applicator 20. In certain embodiments, the adhesive applicator 30 may be used for this purpose, or alternatively, for both purposes herein described (i.e. for both application of an adhesive in combination with epoxy from epoxy applicator 28 in the application of a tie-coat, and for application of an adhesive between the anti-corrosion coating applied by the anti-corrosion applicator 18 and the polymer coating applied by the polymer applicator 20).

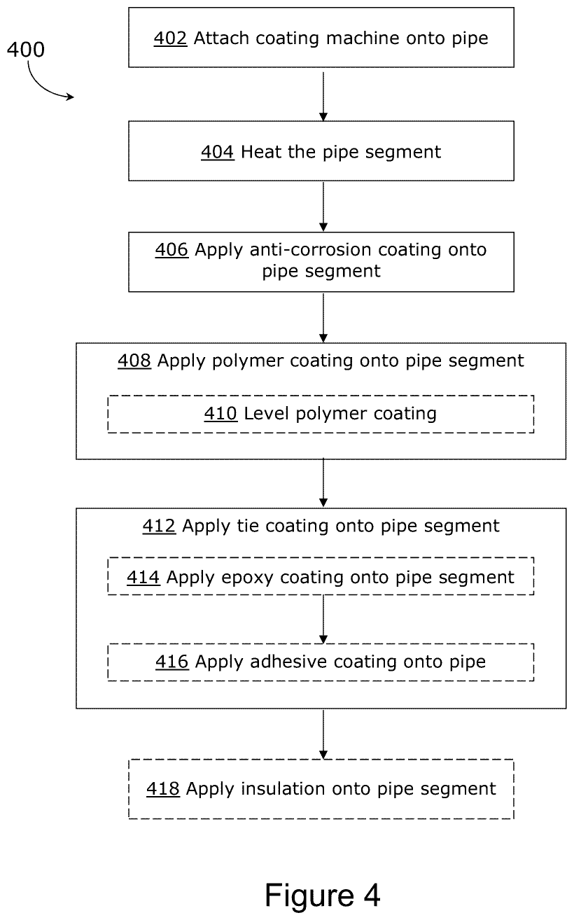

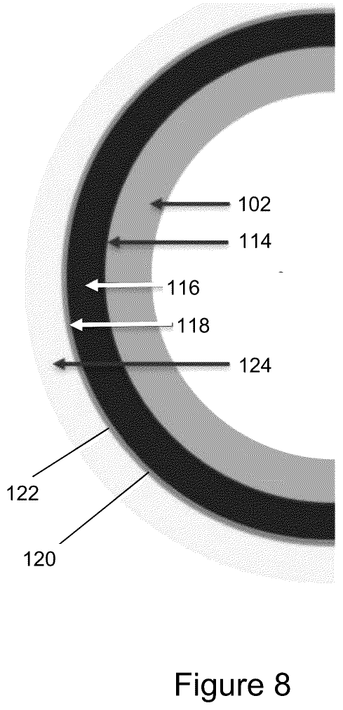

Referring to FIGS. 4 and 7-8, there are illustrated depictions of an example method 400 for applying coatings around a segment of a pipe using coating machine 10 as described above. The following description of method 400 is discussed in relation to pipe segment 102 and coating machine 10 and, thus, may lead to further understanding of coating machine 10. However, it is to be understood that coating machine 10 and method 400 can be varied and need not work exactly as discussed herein in relation to each other, and that such variations are within the scope of the appended claims.

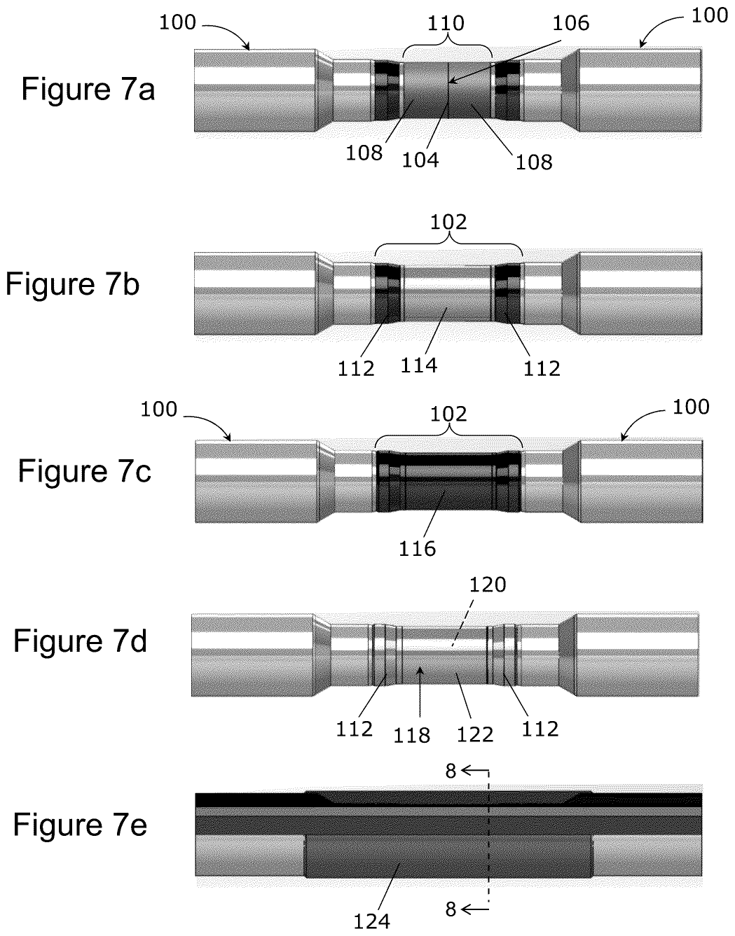

After the metal ends of the pipes are butt welded together to form the conduit and field joint 106, pipe segment 102 is prepared for coating. Pipe segment 102 is prepared by cleaning pipe segment 102, particularly cutback region 110. Rust on cutback region 110 may be removed by sand blasting, acid washing and/or another way bring cutback region 110 to a required level of smoothness and cleanliness. See FIG. 7a for example.

At 402, coating machine 10 is releasably secured to pipe 100 about or proximate pipe segment 102. For example, the non-rotating portion of frame 12 such as a clamp, may be attached to pipe 100.

At 404, pipe segment 102 is then heated by heating element 16, such as IR heater 24 to a desired temperature. In that regard, IR heater 24 radiates heat onto pipe segment 102. Pipe segment 102 is pre-heated to enhance the bonds between subsequent coatings. If IR heater 24 is secured to the non-rotating portion of frame 12, pipe segment 102 is heated from a stationary source relative to pipe 100. Additionally or alternatively, if IR heater 24 is mounted on carriage 14, the heat is rotationally radiated onto pipe segment 102.

In the present application, IR heater 24 heats along the length of pipe segment 102, including both steel sections 108 and chamfered sections 112.

In other applications, heating pipe segment 102 may involve applying multiple sources of heat onto different portions of pipe segment 102. For example, one of the multiple sources of heat may be stationary relative to pipe segment 102 and another one of the multiple sources of heat may rotate relative to pipe segment 102. For example, one of the multiple sources of heat may be applied to chamfered sections 112 of pipe segment 102 and another one of the multiple sources of heat may be applied to steel sections 108 of pipe segment 102. If chamfered sections 112 are to be heated to a different temperature than that of steel sections 108, the heater component heating chamfered sections 112 can apply a different level of heat than the heater component heating steel sections 108. Heating chamfered sections 112 heats the existing factory coating which aids in improving adhesion of any coating that is or will be applied over chamfered sections 112.

At 406, an anti-corrosion coating 114 is applied onto pipe segment 102 with anti-corrosion applicator 18 while pipe segment 102 is still hot. Anti-corrosion coating 114 may be powdered fusion bonded epoxy or liquid epoxy that is sprayed onto pipe segment 102. As depicted in FIG. 7b, anti-corrosion coating 114 in the present embodiment is sprayed onto cutback region 110. If anti-corrosion coating 114 is a powder, the heat from heated pipe segment 102 “melts” the powder therein. In some applications, anti-corrosion coating 114 may be sprayed onto both cutback region 110 and chamfered sections 112. In yet other applications, anti-corrosion coating 114 may be applied in multiple layers onto pipe segment 102, such as sequentially or consecutively.

Before anti-corrosion coating 114 has a chance to cool or cure, at 408, a polymer coating 116 is applied onto pipe segment 102 on top of anti-corrosion coating 114 with polymer applicator 20. Polymer coating 116 may be a sheet of molten polymer, for example, polyethylene, that is extruded onto pipe segment 102 on top of anti-corrosion coating 114. As depicted in FIG. 7c, polymer coating 116 in the present embodiment is extruded onto cutback region 110. In other applications, polymer coating 116 may be extruded onto both cutback region 110 and chamfered sections 112. In yet other applications, polymer coating 116 may be applied in multiple molten sheet layers onto pipe segment 102, such as sequentially or consecutively.

Optionally, at 410, polymer coating 116 may be pressed or levelled against the outer surface of pipe segment 102 by roller 26 in order to achieve a smooth polymer coating.

As noted above, given the relative arrangement of IR heater 24, anti-corrosion applicator 18, and polymer applicator 20, and the rotation of carriage 14 in one direction, anti-corrosion coating 114 is applied immediately or very shortly after a section of pipe segment 102 is heated. Immediately or very shortly after anti-corrosion coating 114 is applied onto the section of pipe segment 102, polymer coating 116 is applied onto the same section of pipe segment 102 as carriage 14 rotates.

In the present embodiment, carriage 14 is adapted to rotate counter-clockwise. Thus, pipe segment 102 is heated in a counter-clockwise direction, and anti-corrosion coating 114 and polymer coating 116 are also applied in the same counter-clockwise direction. In embodiments where carriage 14 is adapted to rotate clockwise, pipe segment 102 would be heated in a clockwise direction, with anti-corrosion coating 114 and polymer coating 116 being consecutively applied in the same clockwise direction.

At 412, method 400 may further include applying a tie coating 118 onto pipe segment 102 on top of polymer coating 116 with tie-coat applicator 22 before polymer coating 116 has a chance to cool or cure. In the depicted embodiment, applying tie coating 118 includes applying an epoxy coating 120 onto pipe segment 102 at 414, and further applying an adhesive coating 122 onto pipe segment 102 at 416. In the present embodiment, epoxy coating 120 is applied on top of uncured polymer coating 116 and adhesive coating 118 is applied on top of uncured epoxy coating 120. In one example, tie coating 118 comprises a mixture of epoxy and adhesive.

Epoxy coating 120 and adhesive coating 122 may be applied in powdered or liquid form that is sprayed onto polymer coating 116 on pipe segment 102. As depicted in FIG. 7d, tie coating 118 in the present embodiment is sprayed onto both cutback region 110 and chamfered sections 112. In other applications, tie coating 118 may be sprayed onto just cutback region 110.

Alternately, applying tie coating 118 may only include applying epoxy coating 120 onto pipe segment 102, or only include applying adhesive coating 122 onto pipe segment 102. In the above cases, epoxy coating 120 and adhesive coating 122 may each be applied in multiple layers onto pipe segment 102, such as sequentially or consecutively.

Further to the above, in the present embodiment, epoxy coating 120 is applied immediately or very shortly after polymer coating 116 is applied onto the section of pipe segment 102, and adhesive coating 122 is applied immediately or very shortly after epoxy coating 120 is applied onto the same section of pipe segment 102 as carriage 14 rotates. In such a manner, the previous coatings remain uncured or only partially cured before the subsequent layer is applied, thus helping to enhance the bond between the layers.

Optionally at 418, insulation material 124 may be applied on top of tie coating 118. Insulation material 124 may be applied using extrusion injection moulding or reactive injection moulding (RIM).

Optionally, and further to the above, adhesive applicator 20 (or, optionally, a further adhesive powder applicator (not shown)) may be used to apply an adhesive, such as an adhesive powder via powder spray, onto the anti-corrosion coating and before the application of the molten polymer sheet by polymer applicator 20. The use of a single coating machine 10 with the ability to spray the adhesive powder quickly after the application of the anti-corrosion coating, and to apply the molten polymer sheet quickly after the resultant adhesive intermediate layer, allows for the adhesive intermediate layer to be applied before the anti-corrosion coating has fully gelled. The adhesive intermediate layer may be heated by the IR heater 24 (or a secondary IR heater (not shown) to keep the adhesive intermediate layer hot before the application of the polymer coating. In this manner, an adhesive intermediate can be quickly and efficiently applied between the anti-corrosion coating and the polymer coating, if such an intermediate adhesive layer is desired or needed for adherence of the polymer coating to the anti-corrosion coating.

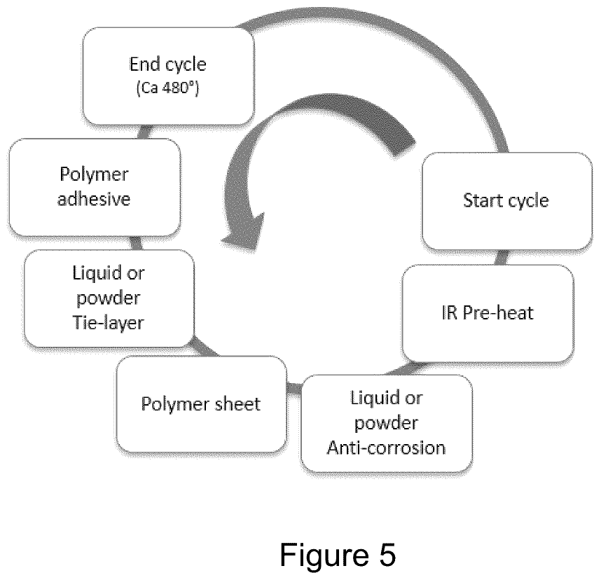

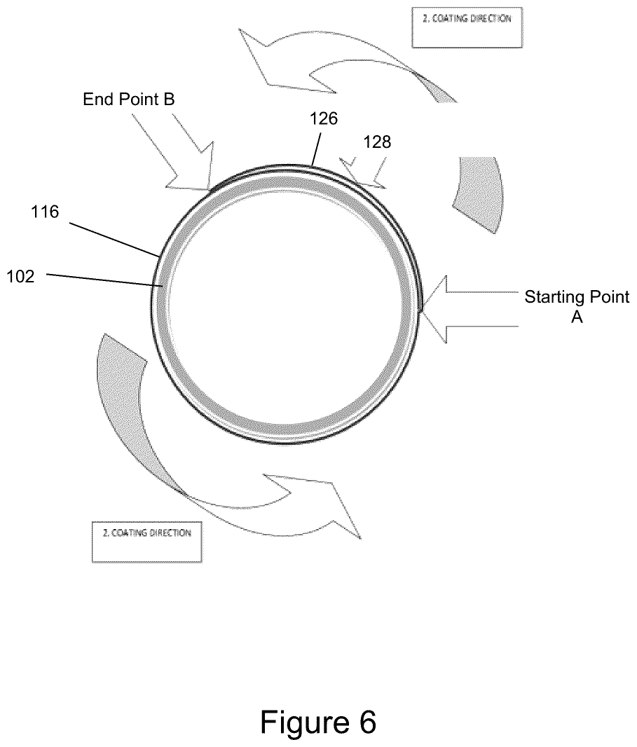

FIGS. 5 and 6 provide alternate illustrations of method 400 using coating machine 10 according to an example embodiment. To start the cycle, IR heater 24 may be positioned at any point around pipe 100. In FIGS. 5 and 6, IR heater 24 is positioned around 4 o'clock and a starting point A is positioned around 3 o'clock. Since carriage 14 is configured to rotate counter-clockwise, the remaining applicators and roller are arranged counter-clockwise from IR heater 24 as described above.

Once carriage 14 begins the cycle, IR heater 24 is activated and begins heating the immediately adjacent section or length of pipe segment 102. As carriage 14 rotates counter-clockwise, anti-corrosion applicator 18 is activated when it reaches 3 o'clock or starting point A and begins applying anti-corrosion coating 114 to pipe segment 102 at starting point A. As carriage 14 continues to rotate counter-clockwise, polymer applicator 20 is activated when it reaches starting point A and begins applying polymer coating 116 onto pipe segment 102 on top of anti-corrosion coating 114 at starting point A. Roller 26 is then also activated when it reaches starting point A.

Although not shown, it is appreciated that an adhesive applicator (not shown) can be configured between the anti-corrosion applicator 18 and the polymer applicator 20, for the application of an adhesive intermediate layer (not shown) immediately on top of the anti-corrosion coating 114 and before the application of polymer coating 116. Alternatively, with the use of an additional rotation, adhesive applicator 30 may be used for this purpose. Additionally, a second IR heater (not shown) may be configured between the anti-corrosion applicator 18 and the polymer applicator 20, to keep the anti-corrosion coating 114 (or, when used, the adhesive intermediate layer) hot before the application of polymer coating 116.

In order to ensure the entire pipe segment 102 has at least one polymer coating 116 with an outermost tie-coating 118 without any gaps, a wrap-over 126 in an overlap region 128 is preferably created. In the present embodiment, overlap region 128 is positioned between starting point A (around 3 o'clock) and end point B (around 11 o'clock) approximately 120 degrees from starting point A. To that end, tie coat applicator 22 is activated at end point B rather than starting point A.

Once anti-corrosion applicator 18 has been activated for a full 360 degree rotation and has returned to starting point A, the entire pipe segment 102 has received anti-corrosion coating 114. However, at least a portion of pipe segment 102 has not yet received polymer coating 116 and an even larger portion has not received tie coating 118.

To create wrap-over 126, carriage 14 continues to rotate counter-clockwise and anti-corrosion applicator 18 continues to apply anti-corrosion coating 114 past starting point A onto polymer coating 116 in overlap region 128. This allows polymer applicator 20 to complete polymer coating 116 on pipe segment 102 and to also continue applying polymer coating 116 past starting point A onto anti-corrosion coating 114 in overlap region 128. Thus, the second anti-corrosion coating 114 in overlap region 128 would be sandwiched between two polymer coatings 116 to create wrap-over 126.

Wrap-over 126 is finished when anti-corrosion applicator 18 and polymer applicator 20 each reach end point B for the second time and are respectively deactivated.

Turning to tie coat applicator 22, as noted above, tie coat applicator 22 is activated when it arrives at end point B for the first time. Tie coating 118 begins to be applied after the first anti-corrosion coating 114 and polymer coating 116 have been applied at end point B. Thus, tie coating 118 is applied onto polymer coating 116 starting at end point B. It continues to be applied onto wrap-over 126 until tie coat applicator 22 rotates back to end point B, where it is then deactivated. In that manner, the outermost coating on pipe segment 102 is tie coating 118 (such as adhesive coating 122), which would assist with the bonding with subsequent insulation material 124.

Since anti-corrosion applicator 18 and polymer applicator 20 reach end point B prior to tie coat applicator 22, they are deactivated and continue rotating before tie coat applicator 22 reaches end point B and is deactivated.

Overall, anti-corrosion applicator 18 and polymer applicator 20 would have been activated for about 480 degrees around pipe segment 102 in one pass or over one cycle. Tie coat applicator 22 would have been activated for about 360 degrees around pipe segment 102 over one cycle.

While overlap region 128 is shown to extend approximately 120 degrees between starting point A and end point B, starting point A and end point B may be positioned at different positions about the circumference of pipe segment 102 such that overlap region 128 is smaller or larger than 120 degrees. In that regard, anti-corrosion applicator 18, polymer applicator 20, and tie coat applicator 22 may be respectively activated and deactivated in order to create a wrap-over 126 that is smaller or larger than 120 degrees around pipe segment 102.

In other applications, starting point A and end point B may be at the same position around pipe segment 102. In such a case, the coatings around pipe segment 102 may not include wrap-over 126.

The use of method 400 with coating machine 10 allows subsequent coatings to be applied onto pipe segment 102 while the prior coat remains uncured, thus helping to provide a stronger bond between adjacent layers. The use of method 400 with coating machine 10 also allows the application of multiple coatings, the anti-corrosion coating, optionally an intermediate adhesive layer, the polymer coating, the epoxy coating, and/or the adhesive coating around pipe segment 102 in a single, automated, pass or rotation, without requiring coating machine 10 to change its direction of rotation. This helps to provides better uniformity in the coatings as well as faster application of the coatings.

Although the present invention and its advantages have been described in detail, it should be understood that various changes, substitutions and alterations can be made herein without departing from the scope of the invention as defined by the appended claims. Moreover, the scope of the present application is not intended to be limited to the particular embodiments of the process, composition of matter, means, methods and steps described in the specification. All references cited herein are hereby incorporated by reference.

1. A machine that is releasably securable to a pipe for applying multiple coatings around a segment of the pipe, the machine comprising:
a frame with a carriage that is rotatable around a periphery of the pipe segment;
a heating element such as an infrared radiation (IR) heater, mounted on the frame for heating the pipe segment;
an anti-corrosion applicator mounted on the carriage for applying an anti-corrosion coating onto the pipe segment; and
a polymer applicator mounted on the carriage adjacent to the anti-corrosion applicator for applying a polymer coating onto the pipe segment;
wherein the anti-corrosion applicator and the polymer applicator apply their respective coatings onto the pipe segment as the carriage rotates in one direction.

2. The machine of claim 1, further comprising an adhesive applicator such as a powder spray applicator mounted on the carriage between the anti-corrosion applicator and the polymer applicator, for applying an adhesive coating onto the pipe segment, and optionally an infra-red element generally proximal to the adhesive applicator.

3-4. (canceled)

5. The machine of claim 1, wherein the pipe segment comprises two pipe ends welded together, referred to as a field joint, and steel sections flanking the field joint, optionally further comprising chamfered sections flanking the steel sections.

6. (canceled)

7. The machine of claim 1, further comprising a tie-coat applicator, such as an epoxy applicator for applying an epoxy coating and/or an adhesive applicator for applying an adhesive coating, mounted on the carriage adjacent to the polymer applicator for applying a tie coating onto the pipe segment,
wherein the tie-coat applicator applies the tie coating onto the pipe segment as the carriage rotates in one direction.

8-9. (canceled)

10. The machine of claim 7, wherein the epoxy applicator is mounted sequentially adjacent to the polymer applicator, and the adhesive applicator is mounted sequentially adjacent to the epoxy applicator.

11. (canceled)

12. The machine of claim 7, wherein one or more of the anti-corrosion applicator, the polymer applicator, the epoxy applicator, and the adhesive applicator each comprises a die or nozzle configured to apply the corresponding coating, optionally in multiple layers, onto the steel sections of the pipe segment and/or onto the steel sections and the chamfered sections of the pipe segment, said of said die or nozzles optionally arranged sequentially.

13-16. (canceled)

17. The machine of claim 1, wherein the IR heater is mounted on (i) a non-rotating portion of the frame and remains stationary relative to the pipe segment as the carriage rotates about the pipe segment and/or (ii) the carriage adjacent to the anti-corrosion applicator, for rotation around the pipe segment.

18. (canceled)

19. The machine of claim 1, wherein the IR heater comprises multiple components configured to apply different levels of heat to different portions of the pipe segment.

20. The machine of claim 19, wherein one of the multiple components is mounted on a non-rotating portion of the frame and another one of the multiple components is mounted on the carriage.

21. The machine of claim 19, wherein one of the multiple components is positioned to heat the chamfered sections of the pipe segment and another one of the multiple components is positioned to heat the steel sections of the pipe segment.

22. A method for applying coatings around a segment of a pipe, the pipe segment optionally comprising two pipe ends welded together, referred to as a field joint, steel sections flanking the field joint, and optionally chamfered sections of coating flanking the steel sections, the method comprising:
releasably securing a coating machine to the pipe proximate the pipe segment, the coating machine having:
a frame with a carriage configured to be rotatable around a periphery of the pipe segment,
a heating element, such as an infra-red (IR) heating element, mounted on the frame,
an anti-corrosion applicator mounted on the carriage, and
a polymer applicator mounted on the carriage;
heating the pipe segment with the heating element;
applying an anti-corrosion coating onto the pipe segment with the anti-corrosion applicator; and
applying a polymer coating onto the pipe segment with the polymer applicator;
wherein the polymer coating is applied following the anti-corrosion coating as the carriage rotates in one direction.

23. The method of claim 22, wherein the coating machine further comprises an adhesive applicator mounted on the carriage between the anti-corrosion applicator and the polymer applicator, and the method comprises applying an adhesive intermediate layer between the application of the anti-corrosion coating with the anti-corrosion applicator and the polymer coating with the polymer applicator.

24-25. (canceled)

26. The method of claim 22, wherein the coating machine further includes a tie-coat applicator mounted on the carriage, the method further comprising:
applying a tie coating onto the pipe segment with the tie-coat applicator,
wherein the tie coating is applied following the polymer coating as the carriage rotates in one direction.

27. The method of claim 26, wherein the tie-coat applicator includes an epoxy applicator and/or an adhesive applicator mounted on the carriage, and wherein applying the tie coating comprises applying an epoxy coating and/or an adhesive coating on the pipe segment.

28. (canceled)

29. The method of claim 27, wherein the epoxy coating is applied following the polymer coating and the adhesive coating is applied following the epoxy coating as the carriage rotates in one direction.

30. (canceled)

31. The method of claim 28, wherein one or more of the anti-corrosion coating, the polymer coating, the epoxy coating, and the adhesive coating is applied onto the steel sections and/or the steel sections and the chamfered sections of the pipe segment.

32. (canceled)

33. The method of claim 28, wherein one or more of the anti-corrosion coating, the polymer coating, the epoxy coating, and the adhesive coating is applied onto the pipe segment in multiple layers, optionally applied sequentially.

34-35. (canceled)

36. The method of claim 22, wherein the heat is radiated onto the pipe segment from a source that is stationary relative to the pipe segment, and/or the heat is radiated onto the pipe segment from a source that is rotationally rotated relative to the pipe segment.

37. (canceled)

38. The method of claim 22, wherein heating the pipe segment comprises applying multiple sources of heat onto different portions of the pipe segment.

39. The method of claim 38, wherein one of the multiple sources of heat is stationary relative to the pipe segment and another one of the multiple sources of heat rotates relative to the pipe segment.

40. The method of claim 38, wherein one of the multiple sources of heat is applied to the chamfered sections of the pipe segment and another one of the multiple sources of heat is applied to the steel sections of the pipe segment.
